(19) United States
(12) Patent Application Publication
(10) Pub. No.: US 2008/0065749 A1
(43) Pub. Date: Mar. 13, 2008

(54) System and method for connectivity between hosts and devices

(76) Inventors: Simge Kucukyavuz, Fort Collins, CO (US); Troy Shahoumian, Fort Collins, CO (US); Dirk Beyer, Fort Collins, CO (US); Julie Ward Drew, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/517,878

(22) Filed: Sep. 8, 2006

(51) Int. Cl. G06F 15/173

(52) U.S. Cl. 709/223; 370/351; 709/226

(57) ABSTRACT

Interconnection links between hosts and devices are optimized by using the operational parameters, for example, the bandwidth, of an edge/core switch network. In one embodiment, integer programming is used to create a mathematical model of the connectivity problem so as to optimize the minimum fraction of each host's or device's bandwidth demand routable from that host or devices to a core switch. In one embodiment, the mathematical model is solved by an integer problem solver.

### CROSS-REFERENCE TO RELATED APPLICATIONS

The present application is related to commonly-assigned U.S. Published Patent Publication No. 2006/0080463, entitled “INTERCONNECTION FABRIC CONNECTION” the disclosure of which is hereby incorporated herein by reference.

### TECHNICAL FIELD

The present invention relates to interconnection fabrics, and in particular connecting hosts and devices via an interconnection fabric.

### BACKGROUND OF THE INVENTION

A storage area network (SAN) is a network of computer storage devices and host servers interconnected by physical communication links. The communication links within a SAN transfer data between various storage devices and hosts computers cables and storage devices do not have to be physically moved to transfer data from one server to another. In this way, several computers may access the same set of files over a network.

The switches, hubs and interconnections of these parts of a SAN are referred to as an interconnection fabric. An interconnection fabric is a mesh of physical links through which hosts and devices simultaneously communicate with each other. The links typically comprise a plurality of switches and hubs. Data flow across a given link is limited and switches and hubs have a finite number of ports. These limitations prevent all hosts from linking to all devices in the network.

### BRIEF DESCRIPTION OF THE DRAWINGS

FIG. 1 is an example of one embodiment of an interconnection fabric that allows for interconnection of hosts and devices;

FIG. 2 is an example of one embodiment of an edge/core switch fabric;

FIG. 3 is an example of possible links between hosts and devices in an interconnection fabric according to one embodiment of the present invention;

FIG. 4 shows a block diagram of a system and method for optimizing an interconnection fabric according to one embodiment of the present invention;

FIG. 5 shows one example of an embodiment having optimized links established between hosts, devices and the switching fabric; and

FIG. 6 shows a flow chart illustrating one embodiment of a method of optimization of an interconnection fabric.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are preformed in one or more modules as desired, and the embodiments described are merely examples. The software is executed on a digital signal processor, ASIC, microprocessor, or other type of processor operating on a computer system, such as a personal computer, server or other computer system.

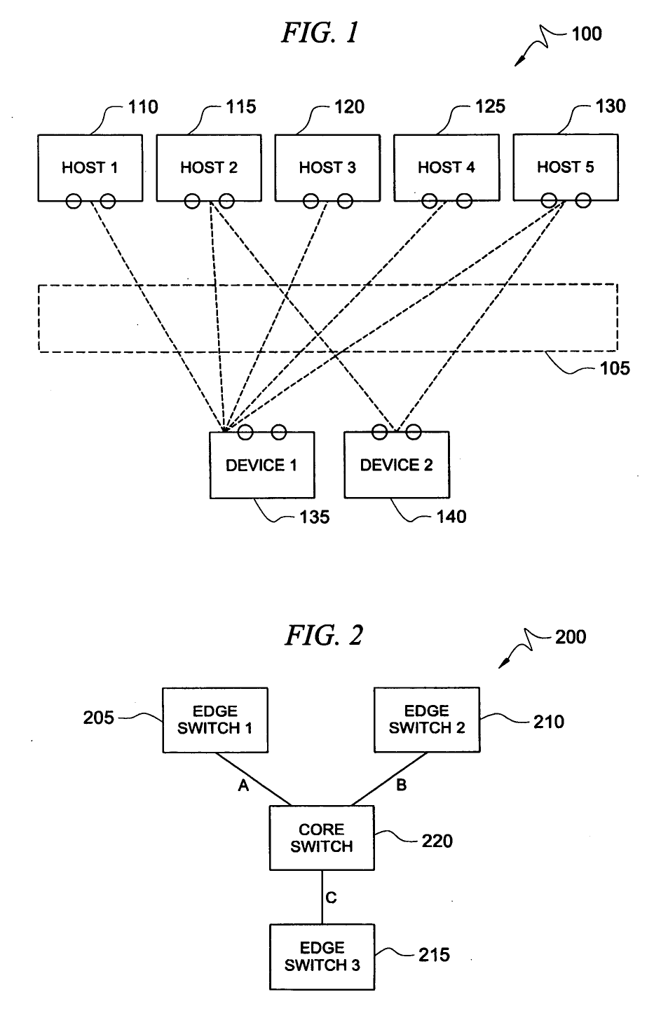

FIG. 1 is an example of one embodiment of an interconnection fabric that connects hosts and devices. The system is indicated generally at 100 and is representative of a typical set of terminals to be coupled by an interconnection network (fabric) indicated by broken line 105. In this simplified example embodiment, hosts, such as host 1 indicated at 110, host 2 indicated at 115, host 3 indicated at 120, host 4 indicated at 125 and host 5 indicated at 130 are to be selectively coupled to device 1 indicated at 135 and device 2 indicated at 140. In one embodiment, the devices are storage devices, and the hosts are computer systems, such as personal computers and servers. This type of system, including the interconnection network 105, is commonly referred to as a storage area network (SAN). Many more hosts and devices may be connected in further embodiments.

There are many different ways in which the hosts and devices may be connected to and through the interconnection fabric. The above-identified publication, U.S. Patent Publication No. 2006/0080463, involves connecting communication links between hosts and devices in a SAN utilizing a particular template topology with specific design requirements and uses an objective function to determine connections through the fabric. The desire is to determine how such connections should be made to make efficient use of the interconnection fabric. Variables and constraints related to the hosts, devices and interconnection fabric are identified and encapsulated in a mathematical language to create a model of an optimum set of connections through the fabric based on a multitude of parameters. In one example, an integer program is used to solve the connection problem. The parameters that are used (as will be discussed) cover a wide variety of factors and from time to time can be changed as system requirements change so as to update the fabric connectivity.

The integer program is then fed into an integer programming solver to provide an output identifying a desirable solution. The solver automatically determines the connectivity of host and device nodes to the interconnection topology, and the routing of flows through the resulting network to minimize congestion and latency of flows if a feasible solution to the connectivity/routing problem exists. It can also automatically determine which parts of the given interconnection topology to exclude in order to minimize hardware costs. The connectivity provided by the solution can be cost-effective and provide low latency.

In one interconnection problem example, each host and device is defined as having two ports, each with a bandwidth of approximately 200 MBps (megabits per second). Lines are shown between selected hosts and devices in one embodiment. Each line indicates a flow requirement between a host and a device pair that needs to be connected via the fabric 105. A flow requirement is represented by a number of megabits per second. The flow requirement may be specified based on expected requirements by a designer of a system, or may be predetermined based on host and device capacities.

FIG. 2 is an example of one embodiment of an edge/core switch network which forms connection fabric 200. Fabric 200 is a simplified example comprising three edge switches, switch 1 at 205, switch 2 at 210 and switch 3 at 215, and a core switch at 220. In further embodiments, many more edge switches and core switches may be used such that flows may progress through multiple levels of core switches. Further embodiments may utilize hubs or other types of routing devices.

The switches in connection fabric 200 comprise multiple ports and links between ports, each having a bandwidth, for example, of 200 MBps. Each switch has a total bandwidth of, for example, 800 MBps and four ports. In further embodiments, different switches in the interconnection fabric may have more or fewer ports with different bandwidths.

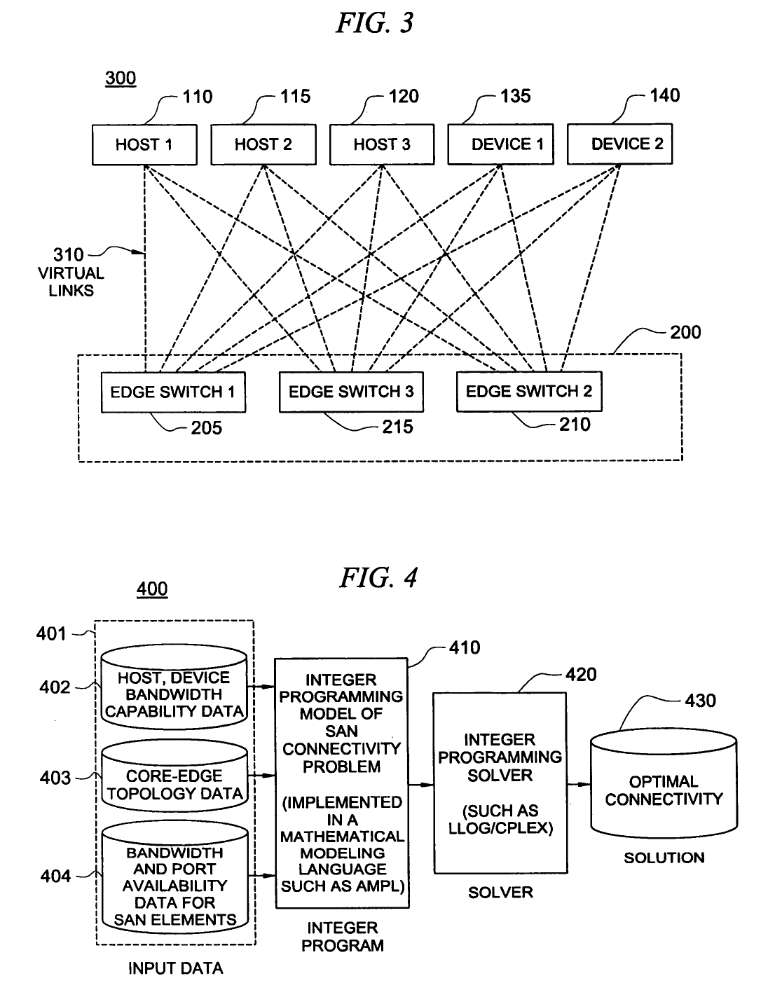

FIG. 3 is an example 300 of possible links 310 between hosts and devices in an interconnection fabric, such as fabric 200, according to one embodiment of the present invention. Links 310 represent possible potential physical connections between hosts and devices through fabric 200. It may not be possible to construct the fabric to accommodate all of these links because of the limited number of ports available on each host and device. Even if it were physically possible, it may be impractical because the resulting network would not be easily scalable.

To determine the optimal configuration, a mathematical model of an optimization problem is created. The optimization problem is drawn from a set of user inputs using, for example, a mathematical programming language such as AMPL. AMPL allows modeling of input data, decision variables, constraints, and objective functions. Other programming languages may also be used, if desired, to construct a model which will optimize the switching fabric by reducing the number of links while still maintaining speed of access and retrieval.

FIG. 4 shows a block diagram of system and method 400 for optimizing the switching fabric in accordance with one embodiment of the invention. The embodiment shown uses integer programming to arrive at a fabric model, but any number of other modeling techniques can be used. An object of the problem is to optimize connectivity to a routing in the interconnection fabric. In one embodiment, the optimal connectivity pattern would take into account the bandwidth demand of the hosts and the devices and would maximize the minimum fraction of each host's and devices bandwidth demand routable from that host or device to a core switch. The method of FIG. 4 passes mathematically represented input data, decision variables, constraints and objective functions to an integer programming a solver which returns a connectivity solution. The input data represents characteristics of the interconnection fabric. The decision variables represent the decisions that the solver is attempting to make. The objective functions represent the goal of the model. The constraints represent rules that a decision must follow. Note that while the discussion focuses on optimizing connectivity, in any particular system the precise optimum solution may, for one reason or another, not be desired or attainable. Thus, a feasible solution can be arrived at by adjusting the parameters of the fabric model.

Input data for the model comprises host device bandwidth capability data 402, a characterization of the interconnection topology data 403, bandwidth and port availability data for SAN elements 404, and any other data pertinent to network topology, system requirements, device constraints, user desires, etc.

Input data is represented mathematically and may also include the following: Let [symbol] represent a set of hosts, [symbol] a set of devices, [symbol] a set of core switches, [symbol] a set of edge switches, [symbol] a set of edge switches in [symbol] that can be connected to hosts only or devices only, which is not necessarily prespecified. Further, let bᵢ^{j} represent bandwidth capacity of port j of a host or a device i, where [symbol] and let [symbol] represent an estimate of bandwidth generated by a host or a device i. If bandwidth cannot be estimated, however, let

$${ℬ}_{i} = {\sum }_{j = 1}^{{p}_{i}} {𝒷}_{i}^{j} .$$

Further, let cₖ denote the bandwidth capacity between edge switch [symbol] and any core switches that it is connected to. Note that because flows can be split, meaning that a flow from host to device may be split across different paths through the network, this is the minimum of edge switch bandwidth capacity and sum of the bandwidth capacities of the links between k and the core switches it is connected to. Finally, let qₜ denote the bandwidth capacity of edge switch [symbol] and let pᵢ represent the number of ports in a host, device or edge switch i open for connection, where [symbol] .

Decision variables are also represented mathematically and may include the following: Let f denote the minimum fraction of input or output capability of a host or a device that can be routed simultaneously through the core; let [symbol] represent the maximum flow between [symbol] and [symbol] through port j of i and port [symbol] of k; let [symbol] equal one if port j of a host or a device [symbol] is open and connected to port [symbol] of edge switch [symbol] or zero otherwise; let [symbol] denote the maximum aggregate flow between edge switch k and core switch t; let [symbol] equal one if edge switch [symbol] can be connected to hosts only, or zero otherwise; let [symbol] equal one if edge switch [symbol] can be connected to devices only, or zero otherwise.

The objectives of the integer programming problem are also represented mathematically and passed to solver 420 by program modeler 410. In one embodiment, the objective function is defined within modeler 410 to maximize the minimum fraction of input or output capability of a host or of a device simultaneously routable through the core. The notation max f denotes this.

The constraints of the integer program problem are also defined mathematically. One such constraint sums the data flow along the ports of all edge switches connected to a given host or device in the network and requires that such sum be greater than or equal to the minimum fraction of total bandwidth capability for that host or device times its total bandwidth capability. The constraint thus maximizes the minimum fraction of routable bandwidth among all hosts or devices in the network. The mathematical representation for this constraint is

$${\sum }_{𝓀 ∈ ℰ} {\sum }_{t = 1}^{{p}_{𝓀}} {\sum }_{j = 1}^{{p}_{i}} \geq {f}_{{ℬ}_{i}} ∀ i ∈ ℋ ⋃ 𝒟 .$$

Another constraint is defined such that [symbol] =1 if port j of a host or a device i is open and connected to port [symbol] of edge switch k. The mathematical representation of this constraint is [symbol] j=1, . . . , pᵢ [symbol] =1, . . . , [symbol] . Note that the flow between two ports cannot be more than the bandwidth of either of those ports. If no link exists between ports, the flow is zero. If a link exists, the flow is constrained by the minimum bandwidth between the ports.

Another constraint is defined such that a given host and a given port on that host, or a given device and given port on that device, cannot connect to more than one port on an edge switch. That is, two links cannot connect to a single port. The mathematical representation for this constraint is

$${\sum }_{𝓀 ∈ ℰ} {\sum }_{t = 1}^{{p}_{𝓀}} {x}_{i 𝓀}^{j 𝓁} \leq 1 ∀ i ∈ ℋ ⋃ 𝒟 , j = 1 , … , {p}_{i} .$$

Likewise, another constraint is defined such that for a given edge switch and a given port on that edge switch, more than one host or device port cannot be connected to that port on the switch. The mathematical representation for this constraint is

$${\sum }_{𝓀 ∈ ℋ ⋃ 𝒟} {\sum }_{j = 1}^{{p}_{i}} {x}_{i 𝓀}^{j 𝓁} \leq 1 ∀ 𝓀 ∈ ℰ \backslash 𝒦 , 𝓁 = 1 , … , {p}_{𝓀} .$$

### The operator\represents set difference.

Three further constraints are defined such that for a given set of edge switches, the switches can be connected either to hosts only or to devices only, but not both. First, if a switch [symbol] is designated as one that can only connect to hosts, then hₖ is equal to 1 indicating that any port on that particular switch can only connect to one host port. If hₖ is zero, switch [symbol] is not restricted to connect only to hosts. The mathematical representations for this constraint is

$${\sum }_{i ∈ ℋ} {\sum }_{j = 1}^{{p}_{i}} {x}_{i 𝓀}^{j 𝓁} \leq {𝒽}_{𝓀} ∀ 𝓀 ∈ 𝒦 , 𝓁 = 1 , … , {p}_{𝓀} .$$

Second, a similar constraint exists for devices. The mathematical representation of this constraint is

$${\sum }_{i ∈ 𝒟} {\sum }_{j = 1}^{{p}_{i}} {x}_{i 𝓀}^{j 𝓁} \leq {𝒹}_{𝓀} ∀ 𝓀 ∈ 𝒦 , 𝓁 = 1 , … , {p}_{𝓁} .$$

### A given edge switch required to only connect to hosts or required to connect only to devices is referred to as the kind that do not mix.

Third, switches are useless if they both must not connect to hosts nor devices, thus [symbol] + [symbol] ≦1

[symbol]

This represents a restriction on the input parameters. Note that if an edge switch k is prespecified as connected to hosts only then the constraint hₖ=1 is added to the formulation. The reprovisioning embodiment below discusses this further.

Another constraint is defined such that the flow into and out of an edge switch does not exceed the bandwidth that could be sent between the edge switch and the core switch it is connected with. The mathematical representation for this constraint is

$${\sum }_{i ∈ ℋ ⋃ 𝒟} {\sum }_{j = 1}^{{p}_{i}} {\sum }_{𝓁 = 1}^{{p}_{𝓀}} {y}_{i 𝓀}^{j 𝓁} \leq {c}_{𝓀} ∀ k ∈ E .$$

Another constraint is defined such that the bandwidth into and out of a given core switch cannot exceed the bandwidth capability for that core switch. The mathematical representation for this constraint is [symbol] [symbol] Where [symbol] is the flow variable between an edge switch [symbol] and core switch t.

Another constraint is defined such that all the flow into an edge switch, either from hosts or devices, has to go into the core and come out of the core. The mathematical representation of this constraint is

$${\sum }_{i ∈ ℋ ⋃ 𝒟} {\sum }_{j = 1}^{{p}_{i}} {\sum }_{𝓁 = 1}^{{p}_{𝓀}} {y}_{i 𝓀}^{j 𝓁} = {\sum }_{t ∈ C} {w}_{{𝓀}_{f}} ∀ k ∈ E .$$

A relationship between the y flow variable and w flow variable is thus defined. Here, the y flow variable describes flows between hosts and devices and edge switches. The w flow variable describes flows between edge switches and core switches.

The domain of [symbol] is {0,1}, that is, a pair of ports can either be connected or not, but not partially connected. The mathematical representation for this constraint is [symbol] ε{0,1} [symbol] j=1 . . . ,pᵢkεE,l=1 . . . pₖ. The value one (1) indicates a connection exists between two ports, the value zero (0) indicates no connection. The domain of hₖ (respectively, dₖ is {0,1}), that is, they can be zero or one, representing the fact that switch k is either unexclusively or exclusively to be connected to hosts (respectively, devices). The mathematical representation for this constraint is hₖ, dₖε{0, 1}

[symbol]

### Further embodiments may introduce additional constraints.

The objective function f and the inequality

$${\sum }_{𝓀 ∈ ℰ} {\sum }_{t = 1}^{{p}_{𝓀}} {\sum }_{j = 1}^{{p}_{i}} {y}_{i 𝓀}^{j 𝓁} \geq {f}_{{ℬ}_{i}}$$

is linearized by summing all the flow over all the edge switches to which device i can connect and then all the pairs of ports between i and those edge switches. That is, sum up all the flow over all the possible links 310 of FIG. 2, and then divide by all the possible flow that i can produce. Note that [symbol] is the total bandwidth generated by i, the desired amount of bandwidth routable if there was unlimited network bandwidth. The mathematical representation of this function is max

$${min}_{i ∈ ℋ ⋃ 𝒟} \{ {\sum }_{𝓀 ∈ ℰ} {\sum }_{𝓁 = 1}^{{p}_{𝓀}} {\sum }_{j = 1}^{{p}_{i}} {y}_{i 𝓀}^{j 𝓁} / {ℬ}_{i} \} .$$

### Note that all the y variables are summed up and considered simultaneously.

Once the mathematical representations of the input data, decision variables, objectives and constrains are passed to optimizing program solver 420, an optimal connectivity is established as shown at 430. One example of an optimizing solver is ILOG's solver/CPLEX, however, other solvers may be used. Solution 430 recommends to the network designer how to connect the hosts and devices to the interconnection fabric.

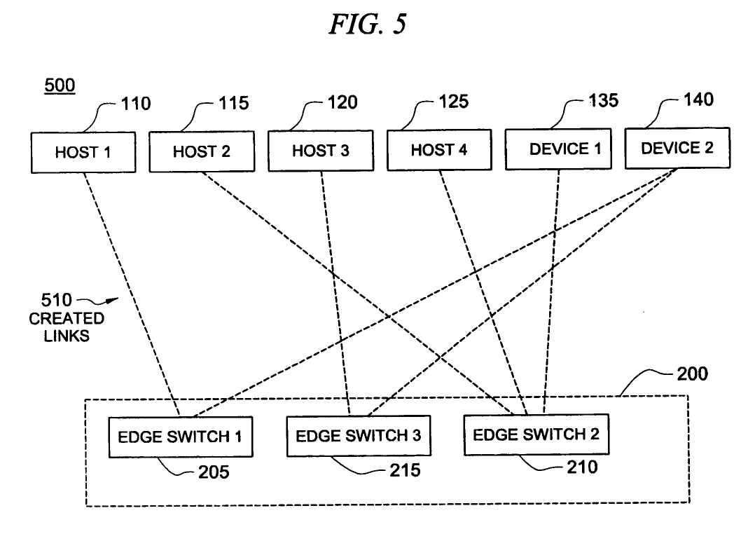

FIG. 5 shows one example of an embodiment having optimized links established between hosts, devices and the switching fabric. In this overly simplified example, host 110 is connectable to device 140 via switch 205; hosts 115 and 125 are connectable to device 135 via switch 210; and host 120 is connectable to device 140 via switch 215.

In further embodiments, redundancy is addressed by considering failures of edge switches and core switches. To address redundancy problems, an objective function is defined to maximize the minimum fraction of input and output over all hosts and devices that can be routed simultaneously through the core under all failure scenarios.

Here, let the decision variable [symbol] represent the flow between port k of host and device i and port [symbol] of edge switch k. Also, let variable wₖₜ denote the flow between edge switch k and core switch t under the failure scenario that an edge switch fails. To consider all edge switch failures, inequality

$${\sum }_{𝓀 ∈ ℰ \text{:} 𝓀 \neq 𝓀} {\sum }_{𝓁 = 1}^{{p}_{𝓀}} {\sum }_{j = 1}^{{p}_{i}} {y}_{i 𝓀}^{j 𝓁} \geq {f}_{{ℬ}_{i}} ,$$

[symbol]

replaces inequality

$${\sum }_{𝓀 ∈ ℰ} {\sum }_{t = 1}^{{p}_{𝓀}} {\sum }_{j = 1}^{{p}_{i}} {y}_{i 𝓀}^{j 𝓁} \geq {f}_{{ℬ}_{i}}$$

from the integer programming model above. The inequality thus considers each host and device and the minimum routable fraction of bandwidth in the case that a switch in the network fails.

The decision variable [symbol] is defined as the flow between port k of host and device i and port f of edge switch k under the failure scenario that a core switch fails. The decision variable [symbol] is defined as the flow between edge switch k and core switch t under the failure scenario that a core switch fails.

Further, the constraints

$${\sum }_{𝓀 ∈ ℰ} {\sum }_{𝓁 = 1}^{{p}_{𝓀}} {\sum }_{j = 1}^{{p}_{i}} \geq {\ddot{y}}_{i 𝓀}^{j 𝓁} \geq {f}_{{ℬ}_{i}} ∀ i ∈ ℋ ⋃ 𝒟$$

and [symbol] ≦qₜ [symbol] are introduced to consider core switch failures. The constraint

$${\sum }_{i ∈ ℋ ⋃ 𝒟} {\sum }_{j = 1}^{{p}_{i}} {\sum }_{𝓁 = 1}^{{p}_{𝓀}} {\ddot{y}}_{i 𝓀}^{j 𝓁} = {\sum }_{t ∈ c \backslash \{ {c}^{i} \}} {\ddot{w}}_{𝓀 f} ∀ 𝓀 ∈ ℰ , {c}^{i} ∈ C$$

is also introduced. These constraints are in addition to the integer programming problem constraints set forth above. Note these constraints assume that all components are identical and core-edge is symmetric. Also note that the link failures need not be considered because they are dominated by switch failures.

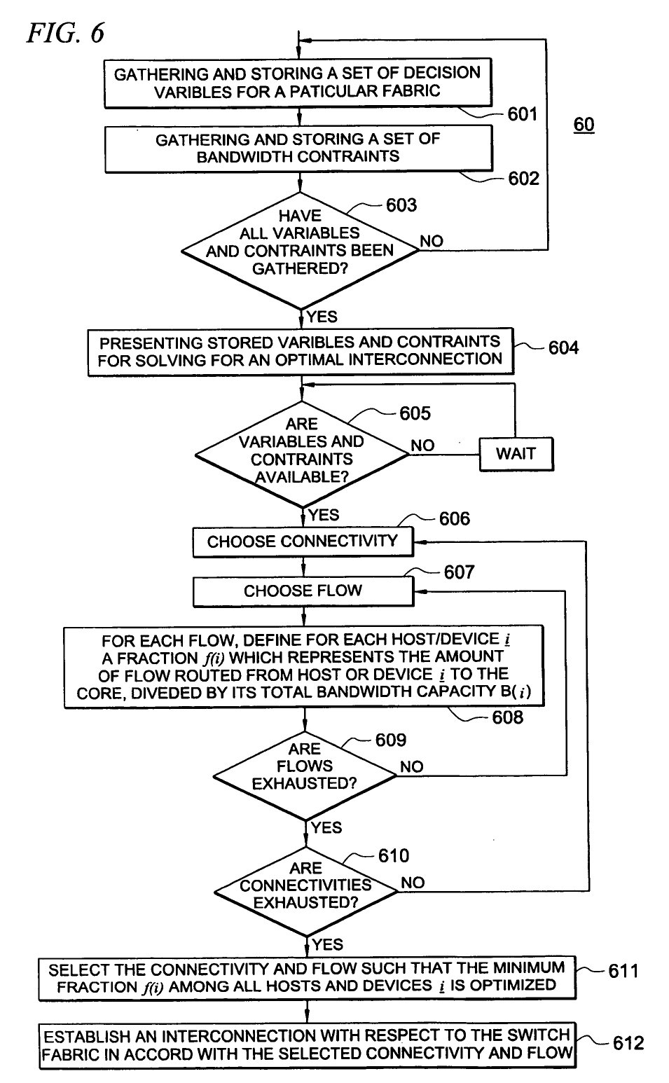

FIG. 6 shows a flow chart illustrating one embodiment 60 of a method of optimization of an interconnection fabric. Note that the processes described in FIG. 6 can, for example, run on a PC, a server or on any other computing device and the code for controlling these processes can be loaded permanently on the computing device or can be downloaded temporarily for controlling the operation of the processes. While the processes of FIG. 6 are shown in several fabrics, it should be understood that the processes, and especially the solution processes (for example processes 606 through 611) can be a single process. Process 601 controls the gathering and storing of a set of decision variables for a particular fabric.

Process 602 controls the gathering and storing of a set of bandwidth constraints for that same interconnection fabric. Process 603 determines when all the variables and constraints have been gathered for a particular interconnection fabric. When that occurs, process 604 presents the stored decision variables and constraints to a model to solve for an optimal interconnection. In this context, an optimal interconnection can be a maximized interconnection or a degraded interconnection as determined by the user and as programmed into the model.

Process 605 determines when all variables and constraints are available. When they are available then process 606 selects a connectivity desired while process 607 chooses a flow. Process 608 then, using the pre-established model for each flow, defines for each host or device i a fraction f(i) which represents the amount of flow routed from host to device to the fabric core divided by its total bandwidth capacity d(i).

Process 609 determines when all flows are exhausted and if they have not been, then a new flow is selected and process 608 continues. Process 610 then determines when all connectivities have been exhausted and when that occurs process 611 selects the connectivity and flow such that the minimum f(i) among all hosts and device i is optimized. When that occurs and the model is complete, then process 61, using the information from the model, establishes an interconnection with respect to the switch fabric in accordance with the selected connectivity and flow.

In a further embodiment, a linear programming problem is presented and solved. In this embodiment, the objective function of the linear program model is defined to maximize f the fraction of bandwidth routable to the core for a given core-edge SAN where hosts and devices are already connected to the edge switches. Here, the variable [symbol] for the existing links between port j of host and device i and port [symbol] of edge switch k. This objective function is constrained such that (i) the sum of data flow along all edge switches and all their ports for a particular host or device in the network is greater than or equal to the minimum fraction of total bandwidth capability of a given host or device times total capability of a given host or device; (ii) [symbol] if port j of a host or a device i is connected to port [symbol] of edge switch k; (iii) a port of a host or a device is connecting only one link to an edge switch; (iv) a port of an edge switch connects only one link to a host or a device for edge switch that can be connected to both hosts and devices.

Another embodiment determines how to reconfigure a network when new hosts or devices are added. Here, an integer program like the one described above is setup such that [symbol] for the existing links between port j of a host or a device i and port [symbol] of edge switch k. The decision variable is thus fixed where a link in the earlier system exists.

What is claimed is:

1. A method of interconnecting hosts and devices via an interconnection fabric containing an interconnected set of edge and core switches, said method comprising:
defining a mathematical model of a desired interconnection fabric between certain hosts and certain devices, each said host and device having a bandwidth demand, said mathematical model designed to optimize a minimum fraction of bandwidth capability of a host or device that can be routed simultaneously through the core switches; and
establishing said interconnection fabric in accordance with a machine calculated feasible and optimal solution of said defined mathematical model.

2. The method of claim 1 wherein said defining comprises establishing an integer program containing decision variables.

3. The method of claim 2 wherein said interconnection fabric establishing comprises computing values to support said machine calculation for said decision variables.

4. The method of claim 3 wherein said values are selected from at least one of the list of: bandwidth of a core switch; input/output demands of hosts and devices; number of ports on said interconnection fabric a device or host can connect to; designation of some or all of said edge switches as only to be connected to hosts or only to be connected to devices.

5. The method of claim 3 wherein said mathematical model is solved by at least one solver selected from the list of: an integer program solver; a constraint program solver.

6. The method of claim 2 wherein said devices are data storage and said hosts use said interconnection fabric to store data to, and retrieve data from, selected ones of said devices.

7. The method of claim 2 wherein said mathematical model contains constraints such that when redundancy is required said model optimizes the minimum fraction of each host's and device's bandwidth demand routable to a core switch even should a specified number of failure events occur, including a failure of any switch, switch port, link, host port or device port.

8. The method of claim 2 wherein said mathematical model further comprises:
reconfiguration of at least one of said hosts, devices or switched links.

9. The method of claim 2 wherein said optimal solution optimizes a percentage of each host's or device's bandwidth requirements routable to any core switch.

10. The method of claim 2 wherein said optimal solution contains constraints selected to ensure at least one of the following occurs: that solutions to the model represent physically feasible interconnections; that all flows routed to an edge switch from hosts or devices are routable to a core switch; or that edge switches marked as to be connected to hosts only or devices only are connected either only to hosts or only to devices but not both.

11. The method of claim 1 wherein said mathematical model defines, with respect to a set of interconnections, a set of flows along links in said interconnection fabric and for a given set of flows along links in said interconnection fabric and for each host and device, an implied fraction of said hosts' or devices' bandwidth routable to a core switch; and wherein said mathematical model is operative to select a particular interconnection and a set of flows so as to optimize the minimum over all hosts and devices of said fraction of the hosts' or devices' bandwidth routable to said core switch.

12. A system for defining an optimal interconnection fabric between a set of hosts and a set of devices, said interconnection fabric having interconnected edge and core switches, said system comprising:
an integer program for accepting decision variables pertaining to a number of constraining factors, said constraining factors including host and device bandwidth demand; and wherein
said integer program is operational for solving said constraining factors by using accepted ones of said decision variables to arrive at a connectivity solution with the objective to maximize a minimum fraction of each host's and device's bandwidth demand routable from that host or device to a core switch.

13. The system of claim 12 further comprising:
an integer solver and wherein said integer program is solved using said integer solver; said solution yielding a feasible interconnection fabric for allowing an exchange of data between said hosts and devices.

14. The system of claim 12 further comprising:
a constraint problem solver and wherein said integer program is solved using said constraint problem solver; said solution yielding a feasible interconnection fabric for allowing an exchange of data between said hosts and devices

15. The system of claim 12 wherein said set of hosts process data; and wherein said set of devices store data.

16. The system of claim 12 wherein said integer program is further operational for at least one of the following: taking into account redundancy of at least one of said hosts, devices or switches such that if a specified number of failure events occur, including a failure of any switch, switch port, link, host port or device port then said minimum fraction of each host's and device's bandwidth demands routable from that host or device to a core switch will be maintained; or for taking into account reconfiguration of at least one of said hosts, devices or switches.

17. The system of claim 12 wherein said integer program contains at least one constraint selected to ensure at least one of the following: ensuring that said connectivity solution represents physically feasible interconnections; ensuring that all flows routed to an edge switch from hosts or devices are routable to a core switch; or ensuring that edge switches marked as to be connected to hosts only or devices only are, connected either only to hosts or only to devices but not both.

18. A program embodied on a computer-readable medium, said program operable for optimizing connectivity of hosts and devices through a switching fabric, said program comprising:
code for controlling the storage of a set of input variables pertaining to hosts and devices to be linked through said fabric, said input variables including bandwidth requirements of said hosts and devices;
code for controlling the storage of a set of bandwidth constraints between links of an edge/core switching network; and
code for presenting stored ones of said variables and constraints to an integer program solver for solving an integer program in order to obtain a feasible pattern for interconnecting said hosts and devices through said switching network.

19. The program of claim 18 wherein said interconnection pattern maximizes a minimum fraction of each host's and device's bandwidth requirements from that host or device to a core switch.

20. The program of claim 19 wherein said integer program is further operable for determining the optimal connectivity when at least one new host or at least one new device is connected to said switching network.

21. A method of interconnecting hosts and devices via an interconnection fabric containing an interconnected set of edge and core switches, said method comprising:
defining a mathematical model of a desired interconnection fabric between certain hosts and certain devices, each said host and device having a bandwidth demand, said mathematical model designed to maximize a minimum fraction of each host's or device's share of the total bandwidth that can be routed to said core switches; and
establishing said interconnection fabric in accordance with a machine calculated feasible and optimal solution of said defined mathematical model.

22. The method of claim 21 wherein said defining comprises establishing an integer program containing decision variables.

23. The method of claim 22 wherein said interconnection fabric establishing comprises computing values to support said machine calculation for said decision variables.

24. The method of claim 3 wherein said mathematical model is solved by at least one solver selected from the list of: an integer program solver; a constraint program solver.
